(19) United States
(12) Patent Application Publication
(10) Pub. No.: US 2005/0274272 A1
(43) Pub. Date: Dec. 15, 2005

(54) Multipurpose label apparatus

(76) Inventor: Ralph Machesky, Littleton, CO (US)

Correspondence Address: Ralph Machesky, 11804 W. Belmont Dr., Littleton, CO, 80127, US

(21) Appl. No.: 10/952,616

(22) Filed: Sep. 29, 2004

Related U.S. Application Data
(63) Continuation-in-part of application No. 10/267,012, filed on Oct. 8, 2002, now abandoned.
(60) Provisional application No. 60/327,989, filed on Oct. 9, 2001.

(51) Int. Cl. B41J 1/56

(52) U.S. Cl. 101/485

(57) ABSTRACT

The present invention relates to a multi-purpose label unit, which can adhere to a number of surfaces depending on the need at hand, provide protection for pre-printed matter, while allowing a user to write on and remove a plurality of indicia. The label unit can be combined with another label unit, to perform a number of functions, a very unique feature. The label unit in it's simplest form can utilize only 2 layers, while the addition of just one more layer increases the level of functionality greatly. The label unit is particularly useful in that it can receive writing or printing on either side of its opaque or transparent layer, allowing reverse printing functionality. The select use of synthetic materials promotes water resistance, allowing the marking receptive outer surface of the label unit to even be used under water. The label unit is especially useful for labels, bookmarks, Post-It® type notes, business cards, page flags, CD and DVD labels and others.

### REFERENCE TO RELATED APPLICATION

This application is a continuation-in-part of copending application Ser. No. 10/267,012, Filed Oct. 8, 2002, which in turn claims priority to U.S. Provisional Application of Machesky, Ser. No. 60/327,989, filed on Oct. 9, 2001, entitled “Magnetic Display Apparatus”, portions of which are expressly incorporated by reference herein.

### BACKGROUND OF THE INVENTION

Labels have been used for years for purposes of conveying addresses of shipping boxes, to listing the items in a filing cabinet drawer. While the purposes of labels vary widely, the means of adherence to objects is generally narrowed to two choices: Self-Stick labels which utilize an adhesive for adhering to a surface, and labels, which must be held by physical holders.

With the ever-growing number of personal computers and printers, a need was filled for consumers by providing ‘label kits’ which allowed the user to print their own labels on specially coated adhesive-backed papers. The label kits were tailored to 3 main types of printers; those that used impact or liquid ink (dot matrix and ink jet) and those that cured toner with heat (laser). The consumer simply selected the label kit that was compatible with their printer, loaded the label material into the printer and printed what they wanted, achieving good results.

Other advances, notably in the fields of thin sheet magnetic receptive materials, have led to the availability of ‘magnetic printing sheets’ which allow users with ink jet printers to print various items including labels, business cards, signs and others which can be magnetically adhered to a ferrous surface.

While self-stick label kits have been commercially available for users with both ink-jet and the Laser printers or copiers, the ‘magnetic printing sheet’ kits are limited to ink jet printers only. Most, if not all magnetic printing sheets are actually a very thin laminate of specialized paper bonded to a thin layer of magnetized material.

Because of the extremely high internal temperatures that a laser printer or copier operates at, damage to the magnetic printing sheet will almost certainly occur if used in a laser printer or copier. Another operational issue is that of the magnetized material itself. Components made from ferrous materials such as rollers, plates and guides in laser printers or copiers can cause the magnetic printing sheet to become stuck within the complicated paper pathways. Furthermore, multiple sheets of magnetic printing sheets should not be loaded into any type of printer or copier paper feed tray. The sheets simply magnetically adhere to themselves, and can only be loaded one sheet at a time, greatly reducing the items that can be printed in volume.

While these specialized printing media have been available for some time now, not all of the needs of consumers have not been fulfilled. Both self-stick labels and magnetic printing sheets suffer from common problems; the printing surfaces are not moisture resistant, not very durable and do not allow the removal of markings once applied. Labels that are of the self-stick varieties have their printing surface exposed to the elements and moisture, and grime and daily use take their toll quickly. Magnetic printing sheets share this limitation and users in both cases are forced to apply a clear overlay or laminate in an attempt to protect their printed works. Applying an overlay or laminate offers better surface durability than without it, but does not always protect against moisture or damage from liquids. The addition of a laminate layer atop a label or magnetic item can help protect the label or magnetic item, but has also precluded the addition of any further markings, such as handwritten information on the inner or outer surface.

Magnetic printing sheets (or thin rolled magnetic sheet) have also been used for years in commercial printing. Modern advances in printing equipment have allowed for printing directly onto a thin vinyl base layer atop sheet magnet, which can also function as a base color for the print job. While many different systems and methods exist for printing on label materials and magnetic materials, ultimately the item has to be laminated with an overlay or covering to help protect the printing or the material below.

Accordingly, there exists a need for a multi-purpose label unit that can overcome all of the limitations encountered in the art thus far, while providing a plurality of uses at the same time. There also exists a need for a multi-purpose label unit kit, which can be used safely with either ink-jet or laser printers or copiers, allowing users to load multiple sheets of printable media, not just one at a time.

### SUMMARY OF THE INVENTION

The present invention relates to a multi-purpose label unit, which can adhere to a number of surfaces depending on the need at hand, provide protection for pre-printed matter, while allowing a user to write on and remove a plurality of indicia. The label unit can be combined with another label unit, to perform a number of functions, a very unique feature. The label unit in it's simplest form can utilize only 2 layers, while the addition of just one more layer increases the level of functionality greatly. The label unit is particularly useful in that it can receive writing or printing on either side of its opaque or transparent layer, allowing reverse printing functionality. The select use of synthetic materials promotes water resistance, allowing the marking receptive outer surface of the label unit to even be used under water. The label unit is especially useful for labels, bookmarks, Post-It® type notes, business cards, page flags, CD and DVD labels and others.

In general, the label unit includes a first 2 sided adhesive layer, comprised of 2 like or unlike adhesives, a second opaque or transparent layer with both an inner and outer surface having marking receptive/removable properties on each side, and can include a third layer of magnetic/magnetically receptive material or combinations thereof.

In one embodiment, a multi-purpose label unit kit is provided having an adhesive layer with 2 sides and 2 different strengths/formulations of adhesive and a second opaque or transparent layer, also with 2 sides. A third, magnetic or magnetic receptive layer can also be included. The inner and outer surfaces of the second layer preferably have marking receptive properties that allow for removal of said markings by various methods, including erasing, wiping, or removal with a cleaning agent. The inner surface of the second layer can receive reverse printing from a plurality of printers and methods including multiple offset, color laser copiers and laser printers. The adhesive layer has a release liner on both sides, allowing a user to expose the adhesive side of their choosing, to create either a permanent or semi-permanent label according to their needs. The inner surface of the second layer is then applied or bonded to one side of the adhesive layer to form a label unit. Due to the numerous features and embodiments of the present invention, they will be detailed further in this application.

### BRIEF DESCRIPTION OF THE DRAWINGS

The invention will be more fully understood from the following detailed description taken in conjunction with the accompanying drawings in which:

FIG. 1 is an profile view of a label unit with a magnetic base layer according to one embodiment of the present invention;

FIG. 2 is a perspective view of two label units magnetically adhered to each other according to another embodiment of the present invention;

FIG. 3 is a perspective view of two label units magnetically adhered to each other and having another portion positioned on opposed sides of a substrate and magnetically adhered to each other across the substrate.

FIG. 4 is a perspective view of two label units magnetically adhered to each other while positioned on opposed sides of a substrate while marking location on the substrate.

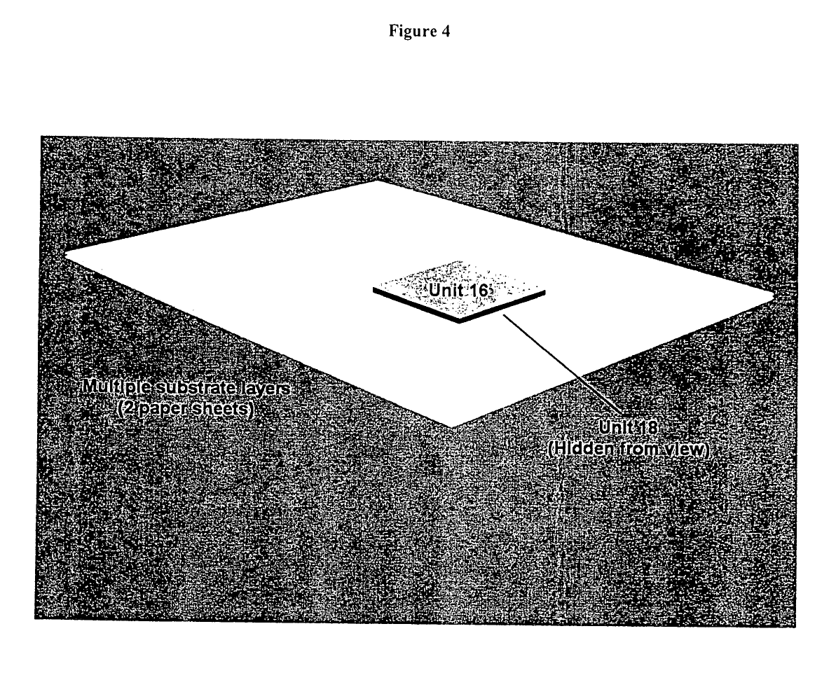

FIG. 5 is a perspective view of a first magnetic layer, a second 2 sided adhesive layer for bonding the third opaque or transparent layer containing reverse printed material in another embodiment of the present invention;

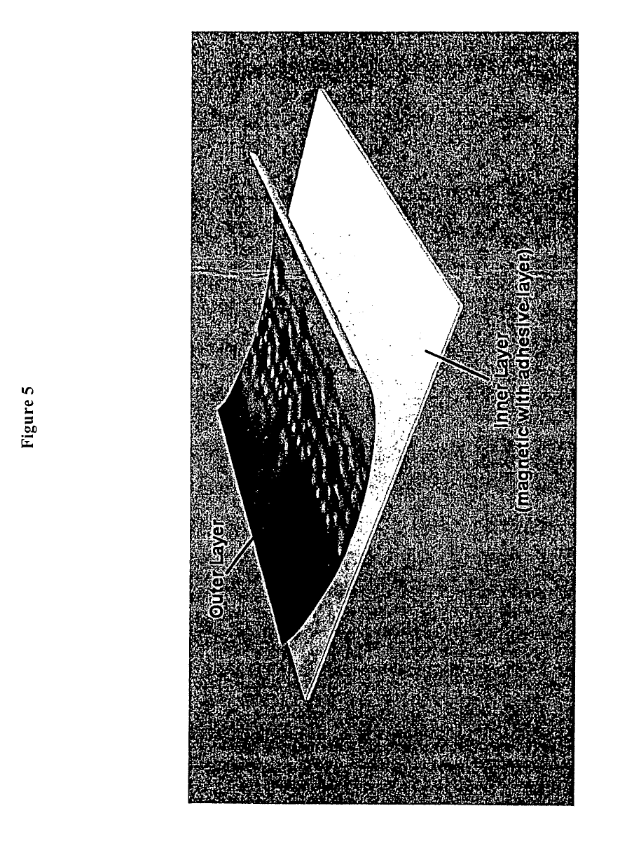

FIG. 6 is a perspective view of a label unit converted from that of a magnetic label unit to that of an adhesive label unit by peeling off all or part of the magnet layer from the label unit.

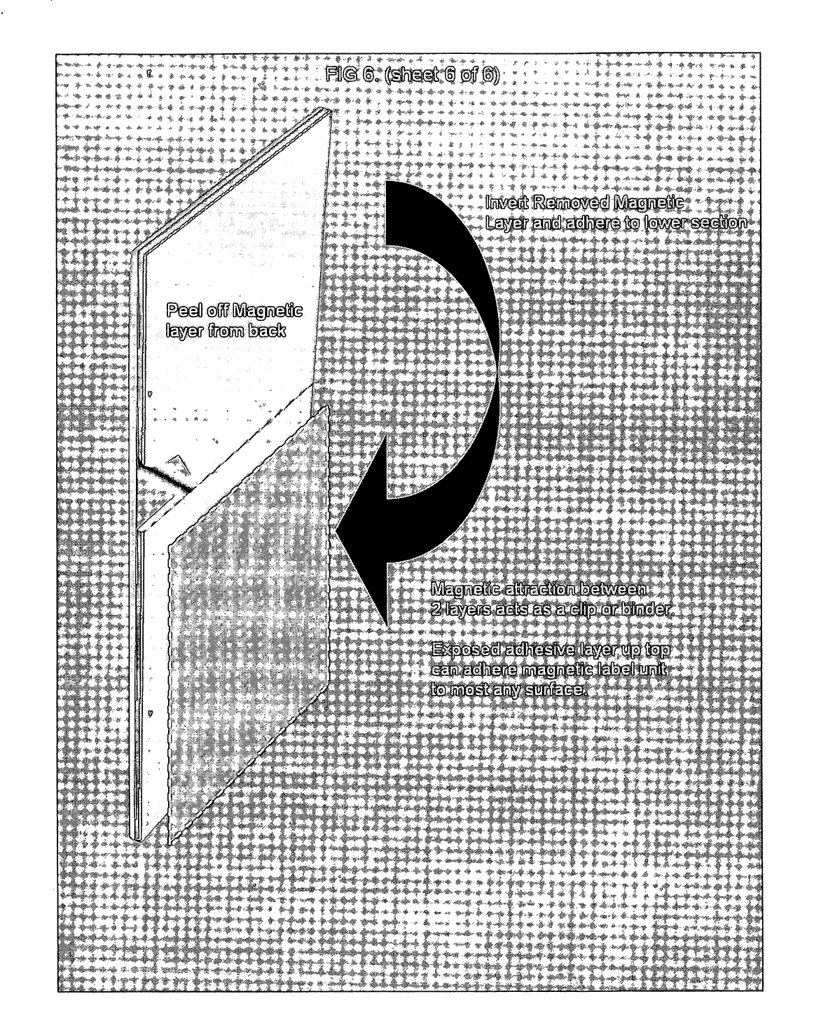

### DETAILED DESCRIPTION OF THE INVENTION

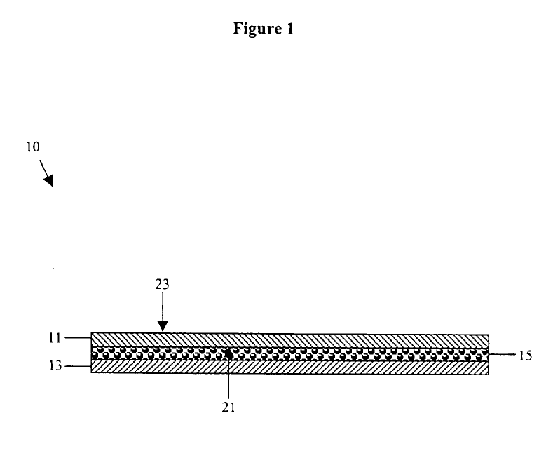

As shown in FIG. 1, the present invention provides a label unit 10 that includes a first magnetic or magnetic receptive layer 13, a second opaque or transparent layer 11, with an inner surface 21 and an outer surface 23, and a 2 sided adhesive layer 15 disposed between the magnetic or magnetic receptive layer 13 and the inner surface 21 of the second layer for bonding the layers together either permanently or non permanently. The inner surface 21 and outer surface 23 preferably have marking-receptive and marking removable properties which allows a user to print or mark on the surfaces thereof, and remove said markings with a number of methods including erasure, wiping or cleaning with an agent. The inner surface 21 and outer surface 23 also both can accept indicia in multiple forms including, ballpoint pen, No. 2 pencil, erasable ink, markers, crayon, grease pencil, ink, toner particles, and indelible marker.

The present invention is particularly advantageous in that the layers can be sold together as a kit, allowing a user to create a number of items with a plurality of uses. The second opaque or transparent layer 11 can be printed upon either side using any supported ink-jet printer, laser printer, or color copier. Commercial printing processes can also print on the material including flexographic, multiple offset, or silkscreen process and others.

A clear advantage of the present invention over prior art is that the second opaque or transparent layer 11 can be fed into a copier or printers feed tray with multiple sheets without regard for which side is face up as both sides 21 and 23 can receive multiple forms of indicia equally well. Because the second opaque or transparent layer 11 is non-magnetic, multiple sheets of media can be loaded and used. Another clear advantage of the second opaque or transparent layer 11 is that it can have marking erased from its surface using rubber eraser, white vinyl eraser, gum eraser, etc. and is not limited to just one kind of eraser that can be used.

While removable indicia such as No. 2 pencil and erasable ink can be simply erased using their own supplied erasers, permanent ink and permanent marker may also be removed with a household cleaner or even denatured alcohol without harming the surface material.

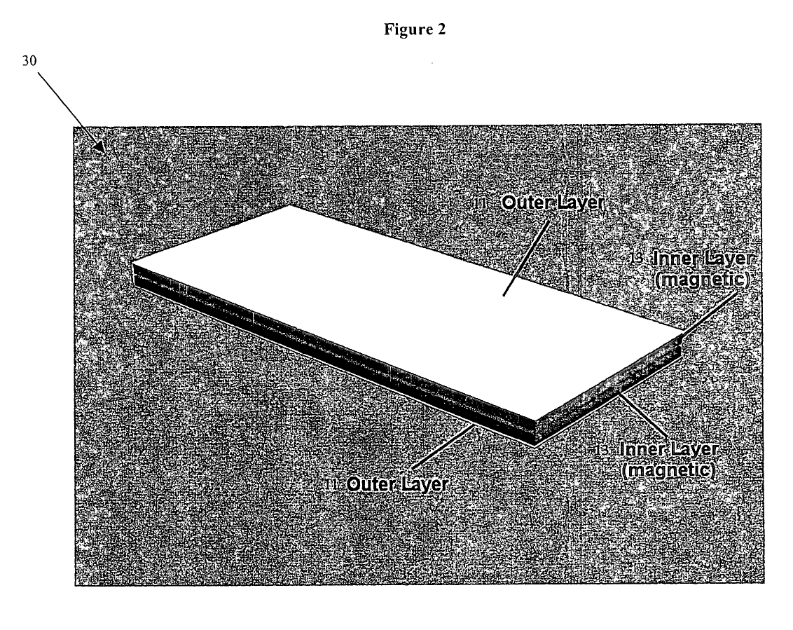

In one embodiment shown in FIG. 2, a label unit apparatus is provided by combining at least 2 label units with a magnetic or magnetically receptive base layer together. Two magnetic or magnetic receptive label units can be placed on opposing but corresponding locations of a plane, such as a page, to serve as a bookmark, location indicator, Post-It® type note, binder, page flag, tab or clip . . . each with a write on and marking removable surface.

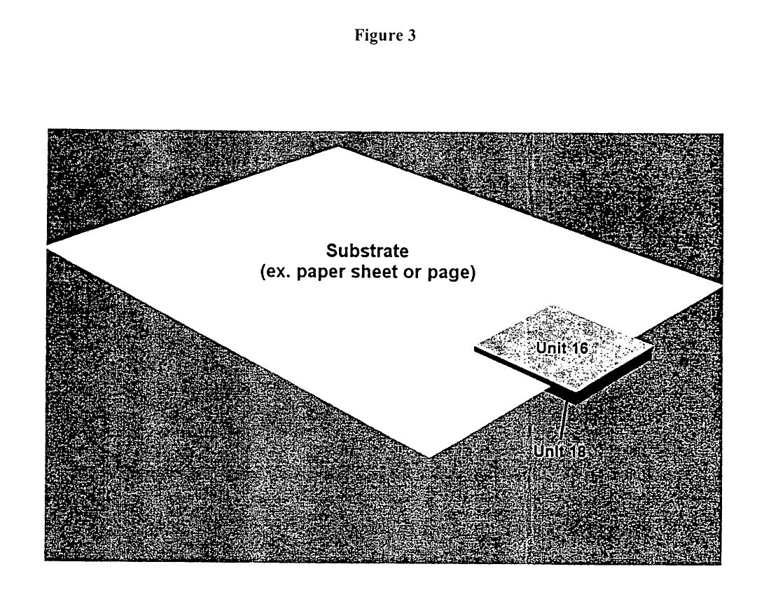

In another embodiment shown in FIG. 3, the label unit apparatus generally includes a first magnetic label unit 16 and second magnetic label unit 18. Each magnetic label unit 16, 18 adheres to the other by magnetic attraction in a fixed position, including when each unit is positioned on opposite sides of a plane such as a page of a book.

Each magnetic label unit 16, 18 can be manually placed at any normally viewable position on a page to mark the location of text or images on that page. For removal, the magnetic label units 16,18 can be separated and moved to another position. Due to the magnetic attraction between the magnetic label units 16, 18, the location on the page is greatly preserved in the event the book is dropped or a breeze blows the books pages.

For further emphasis and clarity, annotations, arrows or other markings can be made directly on the outer surface 23 to draw attention to specifics on a page or surface. An example of use is that of historic photographs or books from a museum. A reviewer or archivist may write notes on the outer surface 23, and then place one of the magnetic label units on each side of a photograph or historic document. The present invention when used as shown in FIG. 3. can overcome the drawbacks of using Post-It® type notes or page flags, which are forbidden by the U.S. Library of Congress (and many others) due to the immense adhesive residue problems that result from their use. An internet search currently turns up over 14,700 hits on this subject alone.

Each magnetic label unit 16, 18 of the label unit apparatus includes an opaque or transparent layer 11, preferably having a material with marking receptive and marking removable properties on both sides, adhered to an inner layer having magnetic or magnetic receptive properties 13. While the preferred embodiment's outer layer 23 can utilize synthetic materials such as DURA-LAR™, or POLYESTER FILM, other synthetic materials with an appropriate coating will work as well.

The disclosed apparatus overcomes the risk of damage and waste of known flimsy paper bookmarks and Post-It™ type notes, which are largely meant to be used for a short while and then thrown away. This is an extremely large waste of both resources and money considering calculations show over one trillion Post-It® type notes have been sold since their introduction in the 1980's.

The apparatus can be made in detailed forms or planar shapes, such as the shape of a telephone or the shape of a commercial advertisers design such as the McDonalds™ logo.

The apparatus can also serve as a telephone book or magazine insert that is not easily dislodged and is highly reusable. An advantage over prior art is that no other adhesive is required to affix the apparatus to the cover or pages. This allows the apparatus to function magnetically in places where adhesives or binding are traditionally used. The apparatus can operate magnetically as a Post-It® type note, label, bookmark, page flag or tab, clip, binder, business card, and others.

In one embodiment, a thin layer of magnetic or magnetic receptive material is supplied with the label unit kit, allowing the user to create a magnetic label unit as above, with the option of a permanent or semi-permanent magnetic or magnetic receptive layer as a base layer. The adherence of the magnetic or magnetic receptive layer to the opaque or transparent layer 11 is determined by allowing a user to choose the desired adhesive type needed. The included 2 sided adhesive layer provides the option of 2 different adhesives types by simply peeling the release liner from the appropriate side of adhesive layer and affixing it to the magnetic or magnetic receptive layer as desired. The user then peels the release liner from the remaining side of the adhesive, (now affixed to the magnetic or magnetic receptive layer) and applies the outer layer 11. Depending on which side of the adhesive layer the user chose to bond the 2 surfaces together with, they can either have a magnetic label unit that has a removable outer layer 11, or removable magnetic layer 13. This distinction offers several advantages over prior art, which are further described in following pages.

While the label unit apparatus has been described largely operating in a magnetic or magnetic receptive manner, it can also function in an adhesive mode or even a combination of adhesive and magnetic attraction at the same or different times. In the example of the label unit kit, the user would simply omit the magnetic or magnetic receptive layer 13, and use only the adhesive layer 15 and outer layer 111 to make an adhesive based label unit.

In another embodiment, a label unit is provided with the adhesive layer 15 having a peel-off liner in which a score, or series of scores or cuts has been made allowing for a partial amount of the adhesive layer to be exposed at a time for immediate use, allowing the other still covered portions of adhesive to be utilized at a later time.

An example of use would be that of a label unit utilized as a Post-It® type note, or label that is removed frequently from the surface to which it was applied. After a number of uses, and dependant on conditions, many adhesives may tend to lose their ‘stickiness’ or adhesive strength. With the present invention, a user would simply peel the remaining liner (or just another portion) from the back of the label unit, exposing a fresh portion of adhesive. This is in strong comparison to prior art which has no built-in provision to reattach a label or Post-It® type note which has lost it's sticking ability or adhesive strength. Due to the high reusability of the present invention, coupled with the option to utilize portions of the adhesive layer at a time, a huge savings both in resources and money are realized, another strong advantage over prior art.

In U.S. Pat. No. 6,265,043 (Avery Dennison) Vinyard, a disc label with writable and erasable qualities are disclosed. The label is removed from a release liner or sheet, which also acts as a guide in placing the label upon a CD or DVD surface. While the label supports writing upon the surface and then erasing, it only supports the use of non-hard tipped writing means. No. 2 lead pencil, ball point pens or the like are not supported, and the product packaging expressly states this. Since the Avery label uses a very thin, soft polyester film coated for writing, hard tipped writing instruments can make a permanent mark or grove into the label, rendering the erasable qualities useless.

Also of note is the fact that the Avery label does not support the use of grease pencil, crayon, or other indicia means, which while not hard tipped, are also not erasable or removable from its' surface.

The Avery U.S. Pat. No. 6,265,043 does not suggest or teach the use of a removable liner or release paper in incremental steps exposing only a partial layer of adhesive at a time. The Avery patent does not suggest or teach the use of adhesives in varying strengths or formulations as the label is meant to be permanently applied to a surface once only. The Avery patent does not suggest or teach the use of multiple indicia means, such as pen, pencil, ink, toner that can be later removed The Avery patent also does not teach or suggest a label kit which would allow a user to create their own labels with either a permanent or non-permanent adhesive. The Avery patent does not suggest or teach the use of 2 label units combined to form an apparatus.

In U.S. Pat. No. 6,153,279 (Charley) discloses a label for application to a substrate, including a removable magnet with printing affixed thereon. The magnet, once removed, cannot be reapplied to the label surface from which it came. This is by design, as the magnet with printing is intended to be a one-time item removed from its label layer and kept by a consumer. While Charley suggests or teaches the use of a transparent layer, it is only suggested or taught as a transparent protective covering, not as an opaque layer, not as a writing layer, nor as a layer which can receive multiple indicia or have indicia removed from it. While Charley also discloses the use of a thin magnetic layer, it does not suggest or teach the use of magnetic receptive materials, and while not magnetic, they can adhere to a magnetized surface. This is in strong comparison to the present invention, which can utilize either magnetic or magnetic receptive materials, an adhesive layer or a combination thereof to adhere to a substrate. Charley also expressly states that printed material is paper affixed atop the magnet layer and covered with a permanent clear laminate as a protective layer.

Charley does not suggest or teach the use of reverse printing or the application of an opaque or transparent layer, which can receive markings and have them removed. Charley does not suggest or teach the use of an adhesive layer in different strengths or formulations. Furthermore, Charley does not suggest or teach the use of a label unit with multiple forms of adherence or operation. Charley also does not suggest or teach a label unit that can be combined to form an apparatus, or the label unit in the form of a kit.

None of the prior art references suggest or teach the use of an adhesive layer with 2 sides that has at least 2 different strengths or formulations. None of the prior art references suggest or teach the use of a release liner on an adhesive layer with 2 sides that can removed in increments to expose a partial amount of adhesive for a purpose. None of the prior art references suggest or teach suggest or teach the use of an opaque or transparent layer which can receive multiple forms of indicia on both sides and allow for removal of it. None of the prior art references suggest or teach the use of a label kit that allows a user to choose what adhesive layer they need for a given task of their created label unit. None of the prior art references suggest or teach the use of 2 or more label units used as an apparatus that can define or mark a location on a substrate. None of the references indicated suggest or teach the use of a label unit being used as a bookmark, location indicator, business card, Post-It® type note, binder, page flag or clip, each with a marking receptive and marking removable surface that can receive multiple forms of indicia. None of the references indicated suggest or teach the of a label unit that can adhere to a substrate with one or more forms of adhesion, or a combination thereof. None of the references indicated suggest or teach the use of a label which can convert to a clip or binder from a single label.

In U.S. Pat. No. 5,727,818 (Schmeida) discloses a label that has a first magnetic layer, an opaque color layer, third writing layer, and a fourth connected transparent cover layer hinged at its uppermost portion. Similar to the Avery patent, the Schmeida invention promotes the use only of non-hard tipped writing instruments. Schmeida's version supports only dry-erase type marker, as its surface does not promote erasure of indelible ink and also similar to Avery, damage to the label surface can result if others are used.

In U.S. Pat. No. 5,727,818 (Ogikubo) discloses a magnetic sheet for display, which can be printed upon using various types of printers including copiers and laser printers. According to the companies current web site and tech specs on their products, the magnet sheet is only to be used in ink-jet printers, (in accordance with prior art). The claims of 1 and 2 in Ogikubo imply the use of the magnet sheet in laser printers and copiers, which is a contestable statement considering no current manufacturer of sheet magnet suggests the use sheet magnet in laser printers or copiers, both of which fuse toner particles at high heat levels, and will damage the material.

In U.S. Pat. No. 6,129,963 (Lesko) discloses a laminated article with an imageable film printed only on a first side. The imageable film can be transparent or white and is covered or overlaid with a transparent laminate layer to protect the printing that is on the first side (not reverse printed, as white does not allow the printing to show through). A further colored substrate is applied to the bottom of laminated article to provide a base color.

Although the present invention has been described in connection with several preferred and alternate embodiments, other alternatives, modifications and variations may be apparent to those skilled in the art and is therefore intended to embrace all such alternatives, modifications and variations as fall within the spirit and scope of the appended claims:

1. An article of manufacture that can adhere to a substrate comprising
a magnetic or magnetically receptive material having a first and second substantially planar surface,
an opaque or transparent layer having a first and second substantially planar surface, with at least one of said surfaces having both marking receptive and marking removable properties,
an adhesive layer having a first and second substantially planar surface, disposed between said magnetic or magnetically receptive material and said opaque or transparent layer with either permanent or non-permanent adhesive on said surfaces.

2. The article of manufacture of claim 1 wherein at least one score line, cut or perforation exists in the first substantially planar surface of the magnetic or magnetically receptive material to facilitate removal that does not pierce completely through to the second substantially planar surface.

3. The article of manufacture of claim 1 wherein said opaque or transparent layer can accept at least one form of indicia and be erased, removed or cleaned off.

4. An apparatus comprised of at least two said articles of manufacture, which can adhere to each other in one or more means of adherence or operation.

5. A method for marking a location on a substrate, comprising the steps of
selecting a substrate coordinate;
positioning said article of manufacture at the selected coordinate on one side of a substrate;
positioning a second said article of manufacture at a substantially corresponding position on the second side of the substrate.

6. An apparatus of claim 4, wherein the articles of manufacture operate or function as a bookmark and wherein said bookmark is positional near the outer periphery of a substrate or on the inner planar surface.

7. An apparatus of claim 4, wherein the articles of manufacture operate or function as a clip or binder and wherein said clip or binder is positional near the outer periphery of a substrate or on the inner planar surface.

8. An apparatus of claim 4, wherein the articles of manufacture operate or function as an adhesive type note and wherein said adhesive type note is positional near the outer periphery of a substrate or on the inner planar surface.

9. An apparatus of claim 4, wherein the articles of manufacture operate or function as a page flag or tab and wherein said page flag or tab is positional near the outer periphery of a substrate or on the inner planar surface.

10. An apparatus comprised of at least two said articles of manufacture, which can be vertically stacked or placed adjacent to each other to increase marking receptive surface area.

11. An apparatus of claim 1, wherein said article of manufacture can be offered in kit form comprising
a magnetic or magnetically receptive material having a first and second substantially planar surface,
an opaque or transparent layer having a first and second substantially planar surface, with at least one of said surfaces having both marking receptive and marking removable properties,
an adhesive layer having a first and second substantially planar surface, adhered to said magnetic or magnetically receptive material with either permanent or non-permanent adhesive on said surfaces;
a release layer or removable liner attached to said second substantially planar surface of said adhesive layer having a first and second substantially planar surface.

12. An apparatus of claim 1, wherein a mode of adherence or operation can be changed from means of magnetic attraction to that of permanent or non-permanent adhesive by removing at least part of said magnetic or magnetically receptive material from the label unit, exposing the said permanent or non-permanent adhesive attached to the said opaque or transparent layer.

13. An apparatus of claim 1, wherein a mode of operation or adherence can be changed to that of
a magnetic clip or binder comprising the steps of
removing at least part of the magnetic or magnetically receptive material from the article of manufacture, exposing the permanent or non-permanent adhesive attached to the opaque or transparent layer;
attaching said article of manufacture to a substrate coordinate via the now exposed permanent or non-permanent adhesive attached to the opaque or transparent layer;
placing a thin, planar object including a piece of paper or photograph between the now separated magnetic or magnetically receptive materials,
attaching said removed portion of said magnetic or magnetically receptive material to the remaining magnetic or magnetically receptive material via magnetic attraction.

14. An article of manufacture that can adhere to a substrate comprising:
an opaque or transparent layer having a first and second substantially planar surface, with at least one of said surfaces having both marking receptive and marking removable properties,
an adhesive layer having a first and second substantially planar surface, with either permanent or non-permanent adhesive on said surfaces,
a release liner with at least one cut, score or perforation allowing for the removal of portions of the release liner at a time exposing either said permanent or said non-permanent adhesive on said adhesive layer.

15. An apparatus of claim 4, wherein the articles of manufacture operate or function as an insert for a publication including a magazine or telephone book and wherein said insert is positional near the outer periphery of a substrate or on the inner planar surface.
